(19) United States
(12) Patent Application Publication
(10) Pub. No.: US 2014/0149865 A1
(43) Pub. Date: May 29, 2014

(54) INFORMATION PROCESSING APPARATUS AND METHOD, AND PROGRAM

(71) Applicant: Sony Corporation, Tokyo (JP)

(72) Inventors: Kazumasa Tanaka, Kanagawa (JP); Kenji Tanaka, Kanagawa (JP); Yukihiro Nakamura, Kanagawa (JP); Yoshihiro Takahashi, Kanagawa (JP); Kentaro Fukazawa, Tokyo (JP); Kyosuke Yoshida, Kanagawa (JP)

(73) Assignee: Sony Corporation, Tokyo (JP)

(21) Appl. No.: 14/085,065

(22) Filed: Nov. 20, 2013

(30) Foreign Application Priority Data
Nov. 26, 2012 (JP) 2012-257826

(51) Int. Cl. G06F 3/0484

(52) U.S. Cl. CPC G06F 3/0484
USPC 715/719

(57) ABSTRACT

There is provided an information processing apparatus including a plurality of feature amount extraction parts configured to extract, from content, a plurality of feature amounts, a display control part configured to control display of an image of the content and information concerning the feature amounts of the content, and a selecting part configured to select display or non-display of the information concerning the feature amounts. The display control part controls display of importance of a scene found on the basis of the display or non-display of the information concerning the feature amounts which is selected by the selecting part.

### CROSS REFERENCE TO RELATED APPLICATIONS

This application claims the benefit of Japanese Priority Patent Application JP 2012-257826 filed Nov. 26, 2012, the entire contents of which are incorporated herein by reference.

### BACKGROUND

The present disclosure relates to an information processing apparatus and method, and a program, and particularly relates to an information processing apparatus and method, and program which allow a substance of content to be easily grasped.

A preview screen for checking a substance of a moving picture content generally includes a preview region for reproducing a moving picture and a time line region having a slider for indicating a reproducing position in a time line.

A user can reproduce the moving picture to check a preview in order to grasp the substance of the content, or can move the reproducing position using a slider to check the substance thereof in order to more quickly grasp. However, it may take a long time to grasp the substance depending on a length of the content.

On the other hand, the user can display an image corresponding to a scene change along the time line so as to check where and how video exists, according to Japanese Patent Laid-Open No. 11-284948 or Japanese Patent Laid-Open No. 2000-308003 as related art.

### SUMMARY

However, the length of the content or the much number of scene changes of the content may cause an increase in the number of images corresponding to the scene changes, leading to difficulty in grasping the substance of the content for the user.

The disclosure is made in view of the above circumstances, and it is desirable to improve operability for grasping a substance of content.

According to an embodiment of the present disclosure, there is provided an information processing apparatus including a plurality of feature amount extraction parts configured to extract, from content, a plurality of feature amounts, a display control part configured to control display of an image of the content and information concerning the feature amounts of the content, and a selecting part configured to select display or non-display of the information concerning the feature amounts. The display control part controls display of importance of a scene found on the basis of the display or non-display of the information concerning the feature amounts which is selected by the selecting part.

The display control part may change the display of the information concerning the feature amounts in accordance with the importance.

The display control part may control display of a scene head image as the information concerning feature amounts in accordance with the importance.

The display control part may display a scene head image high in the importance in a manner that the scene head image high in the importance is larger in size than a scene head image low in the importance.

The display control part may display a scene head image high in the importance in front of a scene head image low in the importance.

The display control part may control display of an object image in which a predetermined object is detected as the information concerning feature amounts in accordance with the importance.

The display control part may display an object image high in the importance in a manner that the object image high in the importance is larger in size than an object image low in the importance.

The display control part may display an object image high in the importance in front of an object image low in the importance.

The display control part, in a case where an object image high in the importance is successively detected along a time line, may display one or more object images high in the importance in a zone in which the object image high in the importance is successively detected.

The information processing apparatus may further include a change part configured to change weighting of the importance. The display control part may change the display of the information concerning the feature amounts in accordance with the importance of which weighting is changed by the change part.

The information processing apparatus may further include a scene extraction part configured to extract a scene in accordance with the importance.

The information processing apparatus may further include a digest generating part configured to the scene extracted by the scene extraction part, and to generate a digest moving image.

The information processing apparatus may further include a metadata generating part configured to generate digest metadata including a start point and an end point of the scene extracted by the scene extraction part.

The information processing apparatus may further include a thumbnail generating part generating a thumbnail image which represents the content from an image of the scene extracted by the scene extraction part.

The information processing apparatus may further include a change part configured to change weighting of the importance. The scene extraction part may extract the scene in accordance with the importance of which weighting is changed by the change part.

According to an embodiment of the present disclosure, there is provided an information processing method including extracting, an information processing apparatus, from content, a plurality of feature amounts, controlling, by the information processing apparatus, display of an image of the content and information concerning the feature amounts of the content, selecting, by the information processing apparatus, display or non-display of the information concerning the feature amounts, and controlling, by the information processing apparatus, display of importance of a scene found on the basis of the display or non-display of the information concerning the feature amounts, which has been selected.

According to an embodiment of the present disclosure, there is provided a program causing a computer to function as a plurality of feature amount extraction parts configured to extract, from content, a plurality of feature amounts, a display control part configured to control display of an image of the content and information concerning the feature amounts of the content, and a selecting part configured to select display or non-display of the information concerning the feature amounts. The display control part controls display of importance of a scene found on the basis of the display or non-display of the information concerning the feature amounts, which has been selected by the selecting part.

According to one embodiment of the present disclosure, a plurality of feature amounts are extracted from content, and display of an image of the content and information concerning the feature amounts of the content is controlled. Then, display or non-display of the information concerning the feature amounts is selected, and display of importance of the scene is controlled which is found on the basis of the selected display or non-display of the information concerning the feature amounts.

According to an embodiment of the present disclosure, a substance of content can be easily grasped.

### BRIEF DESCRIPTION OF THE DRAWINGS

FIG. 1 is a diagram showing a configuration example of an information processing apparatus applying the present technology;

FIG. 2 is flowchart illustrating a content input process of the information processing apparatus;

FIG. 3 is a flowchart illustrating a preview display process;

FIG. 4 is a flowchart illustrating a redisplay process of a preview screen;

FIG. 5 is a diagram showing an example of a preview screen;

FIG. 6 is a diagram showing an example of a preview screen;

FIG. 7 is a diagram showing a display example of a scene change image display section;

FIG. 8 is a diagram showing another display example of the scene change image display section;

FIG. 9 is a diagram showing a display example of a face image display section;

FIG. 10 is a diagram showing a display example of the face image display section;

FIG. 11 is a diagram showing a configuration example of an information processing apparatus applying the present technology;

FIG. 12 is a flowchart illustrating a preview display process;

FIG. 13 is a flowchart illustrating a digest generating process;

FIG. 14 is a diagram showing a display example of a digest generating display section;

FIG. 15 is a diagram showing another display example of a digest generating display section;

FIG. 16 is a diagram illustrating another digest generating method; and

FIG. 17 is a block diagram showing a configuration example of a computer.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, a description will be given of an embodiment for carrying out the present disclosure (referred to as embodiment below). The description is given in the order as follows.
1. First embodiment (preview screen in accordance with importance)
2. Second embodiment (digest generation in accordance with importance)
3. Third embodiment (computer)<

### 1. First Embodiment (Preview Screen in Accordance with Importance)

### Information Processing Apparatus Configuration of Present Technology

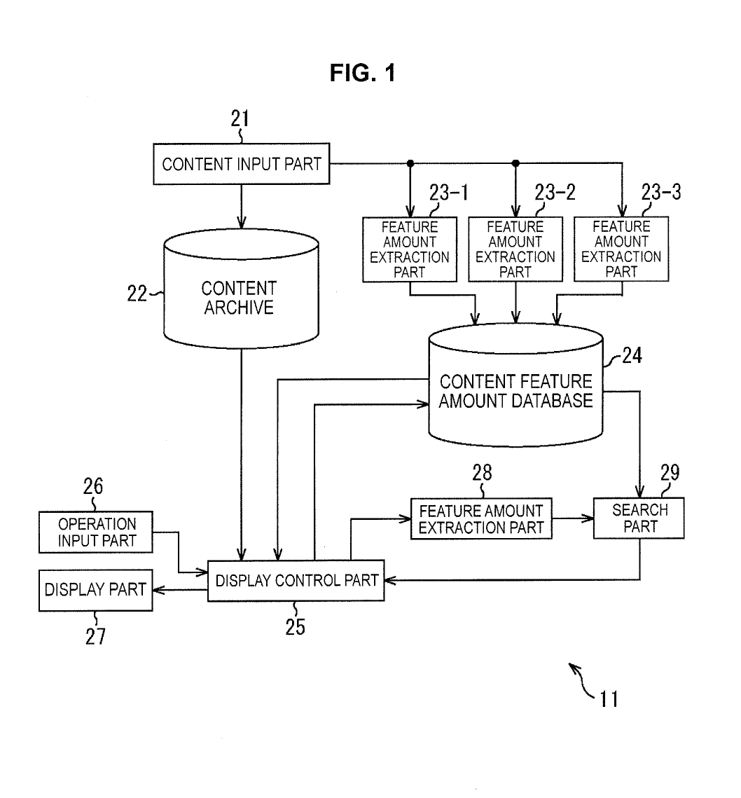

FIG. 1 is a diagram showing a configuration example of an information processing apparatus applying the present technology.

An information processing apparatus 11 shown in FIG. 1 displays feature amounts of content extracted from the content by way of a recognition technology such as image recognition, speech recognition, and character recognition in a screen for previewing content along a time line. The information processing apparatus 11 is constituted by a personal computer, for example.

In an example of FIG. 1, the information processing apparatus 11 is configured to include a content input part 21, content archive 22, feature amount extraction parts 23-1 to 23-3, content feature amount database 24, display control part 25, operation input part 26, display part 27, feature amount extraction part 28, and search part 29.

The content input part 21 receives content from the outside not shown or the like and supplies the received content to the feature amount extraction parts 23-1 to 23-3. Additionally, the content input part 21 registers the received content in the content archive 22.

The content archive 22 has the content registered therein from the content input part 21.

The feature amount extraction parts 23-1 to 23-3 perform the image recognition, speech recognition, character recognition and the like on the content to extract each of a plurality of feature amounts including an image feature amount, speech feature amount and the like. The feature amount extraction parts 23-1 to 23-3 register the extracted feature amount of the content in the content feature amount database 24. Here, the feature amount extraction parts 23-1 to 23-3 include three feature amount extraction parts, but, the number thereof is not limited to three and varies depending on a type (number) of the extracted feature amounts. Hereinafter, the feature amount extraction parts 23-1 to 23-3, when not necessary to be distinguished from each other, are merely referred to as the feature amount extraction part 23.

The content feature amount database 24 has the feature amount of the content extracted by the feature amount extraction part 23 registered therein.

The display control part 25 retrieves, in response to a user instruction from the operation input part 26, content to be previewed and a feature amount of the content from the content archive 22 and the content feature amount database 24, respectively. The display control part 25 generates a preview screen on the basis of a preview image of the retrieved content and the information concerning the feature amount of the content, and controls the display part 27 to display the generated preview screen. In displaying the preview screen, the display control part 25, at a time when supplying text or image information input via the operation input part 26 for which an instruction is issued by the user to the feature amount extraction part 28, receives a search result supplied in response thereto from the search part 29. The display control part 25 displays the preview screen on the basis of the search result.

Further, in displaying the preview screen, the display control part 25, at a time when supplying text or image information input via the operation input part 26 due to the user instruction to the feature amount extraction part 28, receives a search result supplied in response thereto from the search part 29. The display control part 25 redisplays the preview screen on the basis of the search result. The display control part 25, in displaying the preview screen, redisplays the preview screen on the basis of the search result and the feature amount which is input via the operation input part 26 and of which display or non-display is selected by the user. At that time, the display control part 25 determines importance of each scene depending on the feature amount selected by the user, and redisplays the preview screen in accordance with the importance.

Further, the display control part 25, in displaying the preview screen, performs modification, update and the like on the information registered on the content feature amount database 24 on the basis of correction for the feature amount input via the operation input part 26 and the like.

The operation input part 26 includes a mouse, a touch panel laminated on the display part 27, and the like, for example. The operation input part 26 supplies a signal in response to the user operation to the display control part 25. The display part 27 displays the preview screen generated by the display control part 25.

The feature amount extraction part 28 extracts the feature amount of the text or image information that is supplied from the display control part 25 and the user issues an instruction for, and supplies the feature amount to the search part 29. The search part 29 searches the content feature amount database 24 for a feature amount similar to the feature amount from the feature amount extraction part 28 and supplies the search result to the display control part 25.

[Operation of Information Processing Apparatus]

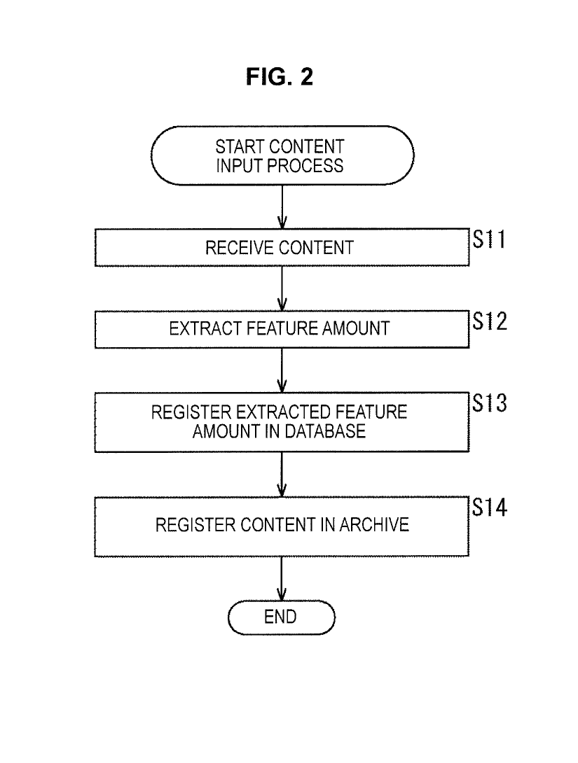

Subsequently, a description will be given of a content input process of the information processing apparatus 11 with reference to a flowchart in FIG. 2.

At step S11, the content input part 21 receives content from the outside not shown or the like. The content input part 21 supplies the received content to the feature amount extraction parts 23-1 to 23-3.

At step S12, the feature amount extraction parts 23-1 to 23-3 perform the image recognition, speech recognition, character recognition and the like on the content from the content input part 21 to extract each of the feature amounts including the image feature amount, speech feature amount and the like. At step S13, the feature amount extraction parts 23-1 to 23-3 register the extracted feature amount of the content in the content feature amount database 24.

At step S14, the content input part 21 registers the received content in the content archive 22.

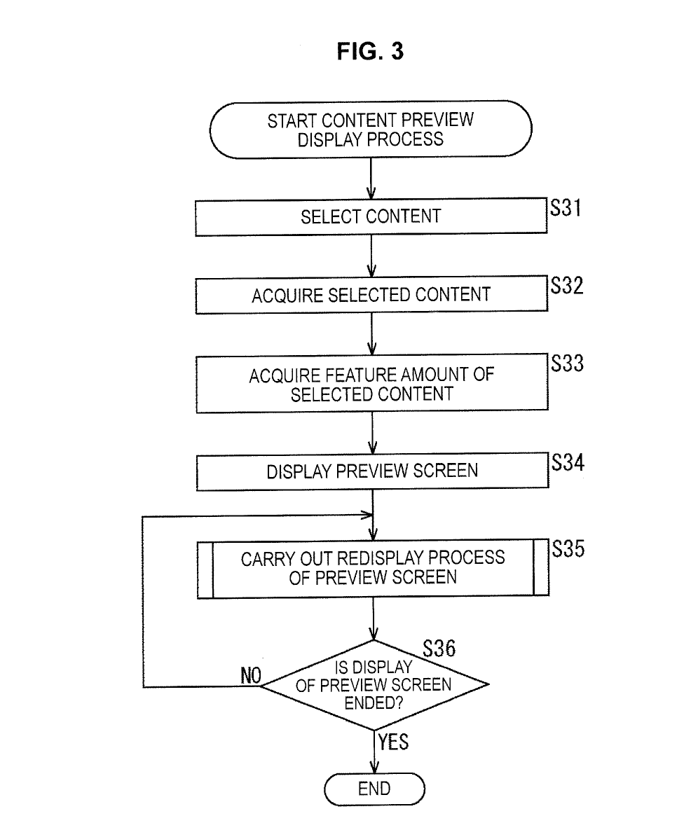

A description will be given of a preview display process of the content which is carried out by use of the content and content feature amount registered as described above, with reference to a flowchart in FIG. 3.

The user operates the operation input part 26 to select content to be previewed. The information of the content selected by the user is supplied via the operation input part 26 to the display control part 25.

At step S31, the display control part 25 selects the content according to the information from the operation input part 26. At step S32, the display control part 25 acquires the content selected at step S31 from the content archive 22.

At step S33, the display control part 25 acquires the feature amount of the content selected at step S31 from the content feature amount database 24.

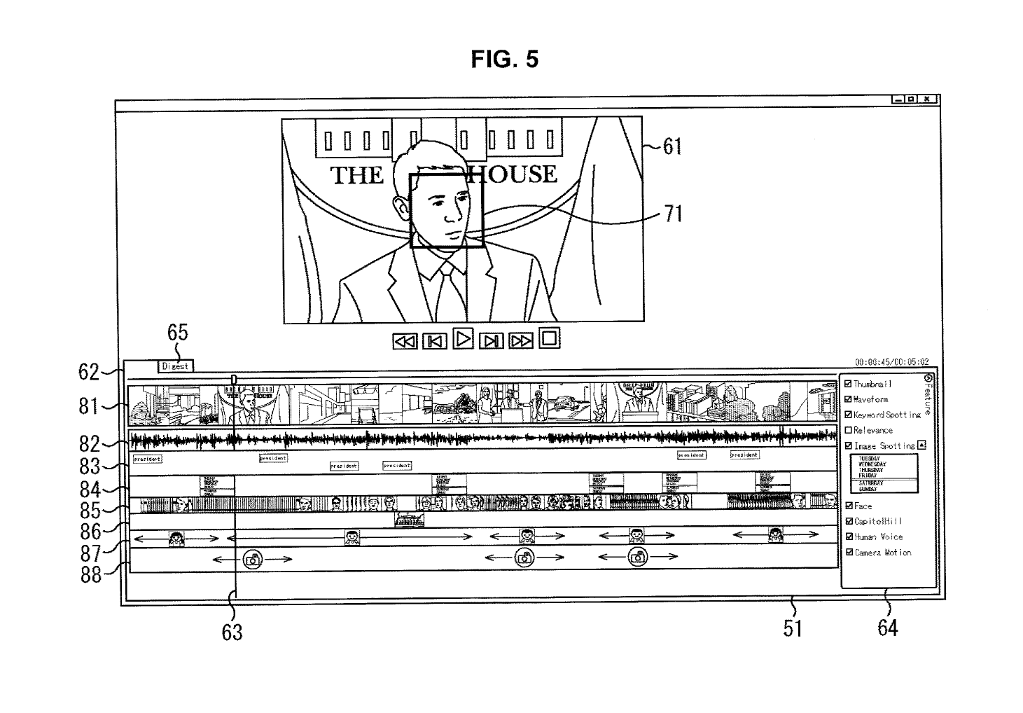

At step S34, the display control part 25 displays a preview screen. In other word, the display control part 25 generates the preview screen in which the information concerning the various feature amounts are displayed along the time line on the basis of the acquired content and the acquired content feature amount, and controls the display part 27 to display the generated preview screen (preview screen 51 shown in FIG. 5 described later). Here, displayed along the time line is not only feature amount information but also information concerning the feature amount. The information concerning the feature amount includes the feature amount information, information obtained by use of the feature amount, or the result retrieved by use of the feature amount.

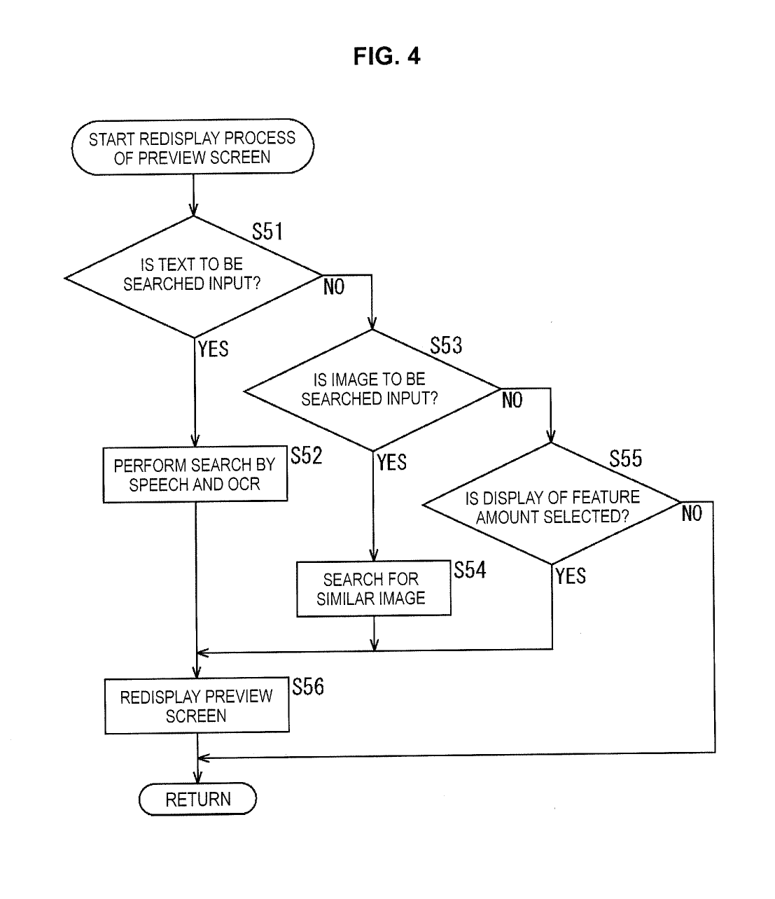

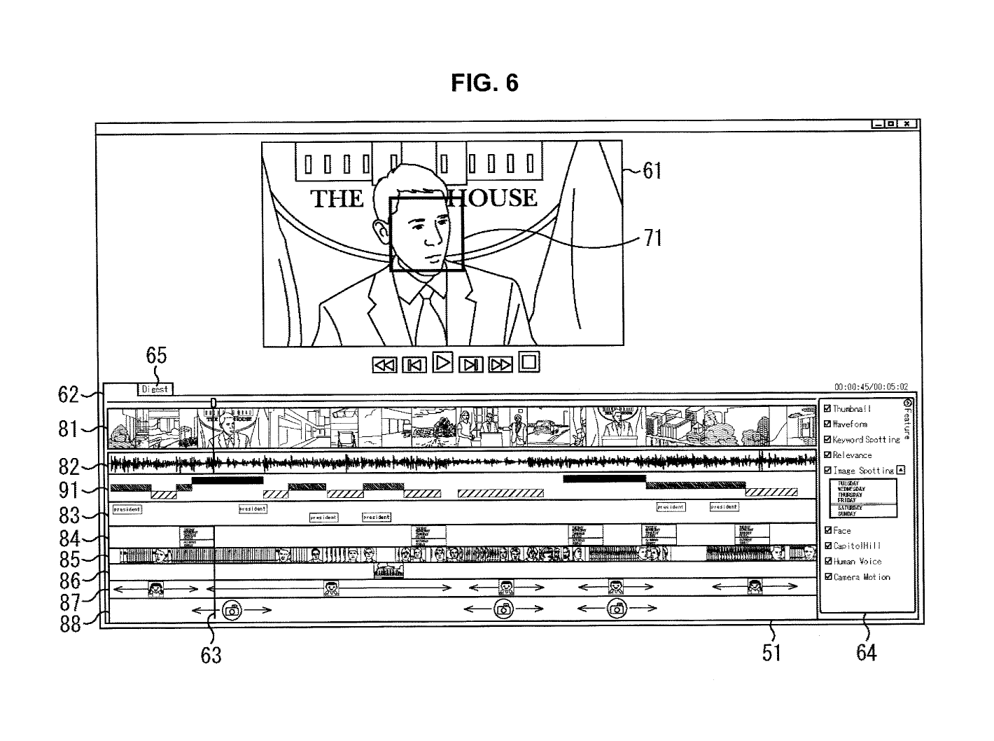

At step S35, the display control part 25 carries out a redisplay process of the preview screen. In this redisplay process of the preview screen, which is described later with reference to FIG. 4, in a process at step at step S35, the preview screen (preview screen 51 shown in FIG. 6 described later) is displayed on the display part 27, the preview screen being updated in response to the user instruction supplied from the operation input part 26.

At step S36, the display control part 25 determines whether or not display of the preview screen ends. If the user issues an instruction for the end via the operation input part 26 at step S36, the preview screen is determined to end and the display of the preview screen ends.

On the other hand, at step S36 if the displaying the preview screen is determined not to end, the process returns to step S35 and repeats step S35 and the subsequent steps.

Subsequently, a description will be given of a preview screen redisplay process at step S35 in FIG. 3 with reference to a flowchart in FIG. 4.

At step S51, the display control part 25 determines whether or not a text to be searched for is input via the operation input part 26. If determined at step S51 that the text to be searched for is input, the display control part 25 supplies information on the input text to be searched for to the feature amount extraction part 28, and the process proceeds to step S52.

At step S52, the feature amount extraction part 28 and the search part 29 perform a search by speech and OCR. That is, in this case, the feature amount extraction part 28 supplies the text to be searched for from the display control part 25 without change to the search part 29. The search part 29 performs a speech search or a character recognition result search on the content feature amount database 24 for the text to be searched for, and supplies the search result thereof to the display control part 25. Then, the process proceeds to step S56.

If determined at step S51 that the text to be searched for is not input, the process proceeds to step S53. At step S53, the display control part 25 determines whether or not an image to be searched for is input the via the operation input part 26. If determined at step S53 that the image to be searched for is input, the display control part 25 supplies information on the input image to be searched for to the feature amount extraction part 28, and the process proceeds to step S54.

At step S54, the feature amount extraction part 28 and the search part 29 search for a similar image. In other words, in this case, the feature amount extraction part 28 extracts the feature amount of the image to be searched for supplied from the display control part 25, and supplies the extracted feature amount of the image to be searched for to the search part 29. The search part 29 searches the content feature amount database 24 for the similar image using the feature amount of the image to be searched for, and supplies the search result to the display control part 25. Then, the process proceeds to step S56.

If determined at step S53 that the image to be searched for is not input, the process proceeds to step S55. At step S55, the display control part 25 determines whether or not the display of the feature amounts is selected via the operation input part 26.

The display or non-display of (the information concerning) the feature amount which is to be displayed along the time line in the preview screen can be selected by the user. If the user selects the display or non-display of at least one of the feature amounts, it is determined at step S55 that the display of the feature amount is selected, and the process proceeds to step S56.

At step S56, the display control part 25 redisplays the preview screen. In other words, after step S52, at step S56, the preview screen is redisplayed in a state where the search result of the text to be searched for is added to (the information concerning) the feature amount to be displayed along the time line. Moreover, after step S54, at step S56, the preview screen is redisplayed in a state where the search result of the image to be searched for is added to the feature amount to be displayed along the time line. Further, after step S55, at step S56, the preview screen is redisplayed in a state where the feature amount to be displayed along the time line is displayed or non-displayed depending on the user selection. After that, the process returns to step S35 in FIG. 3.

If determined at step S55 that the display of the feature amount is not selected, the redisplay process of the preview screen ends and the process returns to step S35 in FIG. 3.

[Example of Preview Screen]

FIG. 5 shows an example of the preview screen.

An example in FIG. 5 shows the preview screen 51 described at step S34 in FIG. 3 or the like, for example.

The preview screen 51 includes the preview display section 61 in which a moving picture of the content can be previewed, and a time line display section 62 which is located lower than the preview display section 61 and displayed by selecting a upper left tab.

The preview display section 61, in response to the user operation on an operation button (reproduction button, fast-forward button, fast-rewind button, stop button and the like) provided immediately below the preview display section 61, reproduces and previews the moving picture of the content. The preview display section 61 displays a box 71 for selecting a face in the displayed content which undergoes a facial recognition in a face image display section 85 described later.

The time line display section 62 displays the information concerning a plurality of feature amounts extracted by the feature amount extraction parts 23-1 to 23-3 in FIG. 1 along the time line. Moreover, a line 63 indicating a position of an image (frame) currently displayed in the preview display section 61 is provided on the time line, and the user can grasp the reproducing position of the content on the time line by getting a look at the line 63.

Further, displayed on the right side of the time line display section 62 is a feature amount list 64 which enables selection of display or non-display on the time line display section 62. The user can check or uncheck a box arranged on the left side of the list to select the display or non-display of the information concerning the feature amount and display only information concerning the desired feature amount.

Note that, in the example in FIG. 5, only the fourth top box “Relevance” in the feature amount list 64 is unchecked. That is, the time line display section 62 in FIG. 5 does not display importance display section 91 (later-described FIG. 6) which is to be displayed by checking “Relevance”.

Further, a digest generating display section 65 is actually provided at the same position as the time line display section 62, but not shown in the example in FIG. 5. By selecting a tab provided upper left of those, the digest generating display section 65 can be displayed in place of the time line display section 62.

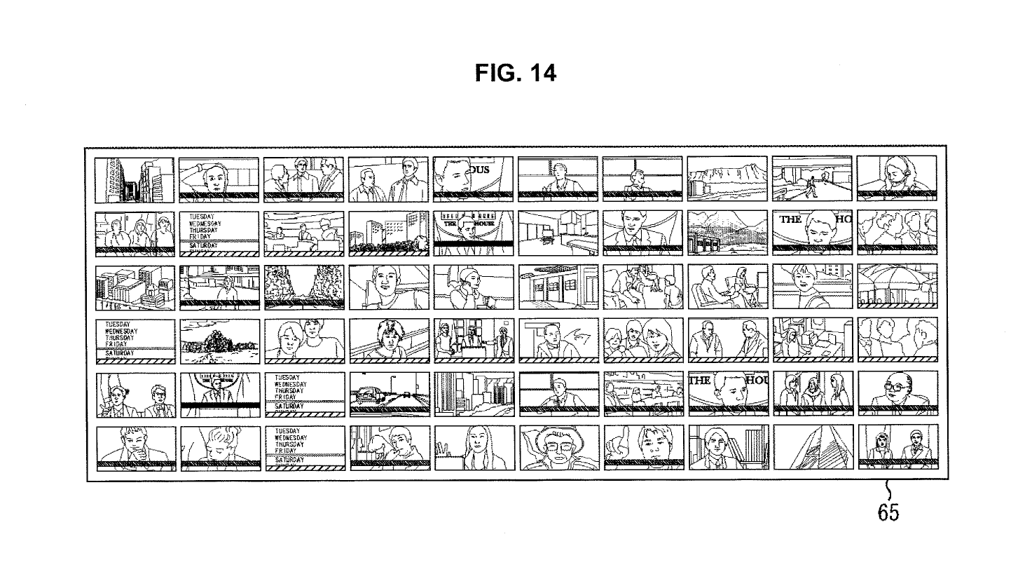

The digest generating display section 65, which is described later in detail with reference to FIG. 14, can be displayed such that a digest moving image or the like is generated.

The time line display section 62 includes a scene change image display section 81, speech waveform display section 82, text search result display section 83, image search result display section 84, face image display section 85, object image display section 86, human speech region display section 87, and camera motion information display section 88 in this order from the top. Any of them is a display section for displaying the information concerning the feature amount.

The scene change image display section 81 is displayed in the time line display section 62 by checking “Thumbnail” in the feature amount list 64. In the scene change image display section 81, a thumbnail image of a head frame image for each scene found by scene change is displayed on the time line as one of the feature amounts. Note that a scene head image is referred to as a scene change image below.

The speech waveform display section 82 is displayed in the time line display section 62 by checking “Wave form” in the feature amount list 64. In the speech waveform display section 82, a speech waveform of the content is displayed on the time line as one of the feature amounts.

The text search result display section 83 is displayed in the time line display section 62 by checking “Keyword Spotting” in the feature amount list 64. In the text search result display section 83, displayed is a result of searching the content feature amount database 24 for the text (“president” in case of the example in FIG. 5) the user inputs by operating the operation input part 26 on the basis of the feature amounts from the speech recognition or character recognition.

The image search result display section 84 is displayed in the time line display section 62 by checking “Image Spotting” in the feature amount list 64. In the image search result display section 84, displayed is (a thumbnail image of) a result of searching the content feature amount database 24 for a scene similar to the image the user selects by operating the operation input part 26 on the basis of the feature amount from the image recognition.

The face image display section 85 is displayed in the time line display section 62 by checking “Face” in the feature amount list 64. In the face image display section 85, displayed is, from content feature amount database 24, (a thumbnail image of) a feature amount similar to the feature amount from facial recognition which is obtained by recognizing a face selected by the box 71 in the preview display section 61.

The object image display section 86 is displayed in the time line display section 62 by checking “Capitol Hill” in the feature amount list 64. Here, in the example in FIG. 5, “Capitol Hill” is an example of an object, but an object is not limited to “Capitol Hill” and can be designated by the user. In the object image display section 86, displayed is (a thumbnail image of) a result of searching the content feature amount database 24 on the basis of the feature amount from recognition of an object (Capitol Hill in case of FIG. 5) designated by the user.

Note that the example is shown in which the face image and the object image are separately displayed, but the face is one of the objects. The image displayed in the face image display section 85 and the object image display section 86 may be an image (thumbnail image) obtained by trimming an extraction object from an original image.

The human speech region display section 87 is displayed in the time line display section 62 by checking “Human Voice” in the feature amount list 64. In the human speech region display section 87, displayed is a human speech region, music region or the like found by the feature amount from the speech recognition. Here, the human speech region display section 87 may display, as shown in FIG. 5, not only a region in which a human speeches but also a mark according to a sex or age of the human of speech.

The camera motion information display section 88 is displayed in the time line display part 62 by checking “Camera Motion” in the feature amount list 64. In the camera motion information display section 88, displayed is a region having the motion information of camera and camera lens (hereinafter, referred to as camera motion information) such as pan, or tilt, zoom which is the feature amount from the camera motion recognition. As the camera motion information, information of a sensor sensing the camera motion in shooting the content or the like can be also used.

In the preview screen 51, various feature amounts, such as the feature amounts described above as the examples, which can be extracted from the content and the information obtained using the feature amounts are displayed along the time line.

However, in the above described preview screen 51, the thumbnail images displayed in the scene change image display section 81, face image display section 85, and object image display section 86 in FIG. 5 are different from each other depending on the length of the content, the number of scene changes or the number of detected objects. This makes it difficult to check each image, leading to difficulty in grasp of the substance of the content.

Therefore, in the present technology, the images including the thumbnail image which are displayed along the time line in the scene change image display section 81, face image display section 85, and object image display section 86 are efficiently displayed depending on the feature amount selected by the user.

In the present technology, for example, the image displayed along the time line is efficiently displayed with a size, a positional relationship between the front and back sides or the like being varied depending on the feature amount selected by the user.

The feature amount the user selects in the feature amount list 64 is a feature amount determined to be important for the user in grasping the substance of the content. For example, if a picture showing people is important, a scene in which people obtained by a face detection appears is important, and if a scene in which a certain word is spoken is important, a scene extracted by the text search in the speech recognition is important.

Accordingly, the display control part 25 determines that a scene corresponding to the feature amount selected by the user is the important scene, and that a scene corresponding to the more feature amounts is the more important scene to determines the importance of each scene.

Here, at that time, the importance may be weighted for each feature amount and a slider may be displayed for operating the weighting of each feature amount such that the user arbitrarily operates the weighting to determine the importance.

The importance determined as described above is displayed in the time line display part 62 as shown in FIG. 6.

FIG. 6 shows another example of the preview screen. In the example in FIG. 6, in the time line display part 62, it is different from the time line display part 62 in FIG. 5 in that the importance display section 91 is newly provided between the speech waveform display section 82 and the text search result display section 83.

Here, anything other than the above in the time line display part 62 in FIG. 6 is basically common to the time line display part 62 in FIG. 5.

The importance display section 91 is displayed in the time line display part 62 by checking “Relevance” in the feature amount list 64. The importance display section 91 displays the importance found by determining that a scene corresponding to the feature amount selected by the user in the feature amount list 64 is the important scene, and that a scene corresponding to the more feature amounts is the more important scene to determines the importance of each scene. Here, the importance is classified into three stages, and importance 3 indicates the highest importance.

For example, the importance display section 91 displays the importance which is determined for each scene in a manner that a solid black region is the most important (importance 3) scene, and subsequently, a fine-hatched region is a scene of importance 2, and a diagonal-hatched region is a scene of importance 1.

Then, the display control part 25 uses this importance to change the display of the information concerning the feature amount in the scene change image display section 81, face image display section 85 or object image display section 86. In other words, in the scene change image display section 81, face image display section 85, or object image display section 86, the image of the more important scene is displayed the more widely and/or on the more front side by use of this importance.

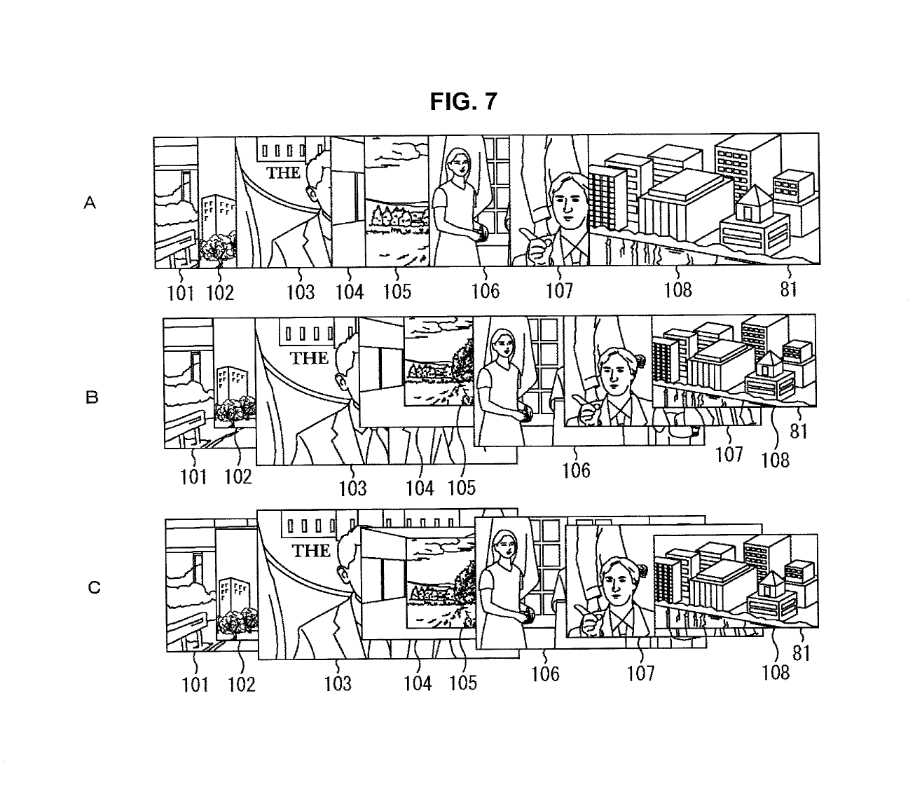

Next, with reference to FIG. 7, a description will be given of utilization of the importance in the scene change image display section 81. In the example in FIG. 7, a thumbnail image 101 to a thumbnail image 108 are displayed from the left in the scene change image display section 81.

A of FIG. 7 shows the scene change image display section 81 in the case of not taking the importance into account. In other words, in the scene change image display section 81 in A of FIG. 7, a thumbnail image of any scene change is displayed with the size being identical and the front and back relationship being along the time line. That is, the thumbnail image 101 which is the first in temporal order is arranged on the most back side, and the thumbnail image 108 which is the last in temporal order is arranged on the most front side.

B of FIG. 7 shows the scene change image display section 81 in the case of enlarging the thumbnail image of the important scene. In other words, in the scene change image display section 81 in B of FIG. 7, the thumbnail image 103 of the most important scene is displayed larger in size than other thumbnail images. The thumbnail images 101 and 106 of important scenes are displayed next larger in size to the thumbnail image 103. Further, the thumbnail images 102, 104, and 107 of slightly important scenes are displayed larger in size than the thumbnail images 105 and 108 of unimportant scenes.

C of FIG. 7 shows the scene change image display section 81, changed from the display in B of FIG. 7, in the case of displaying each of the thumbnail images 101 to 108 with being vertically centered.

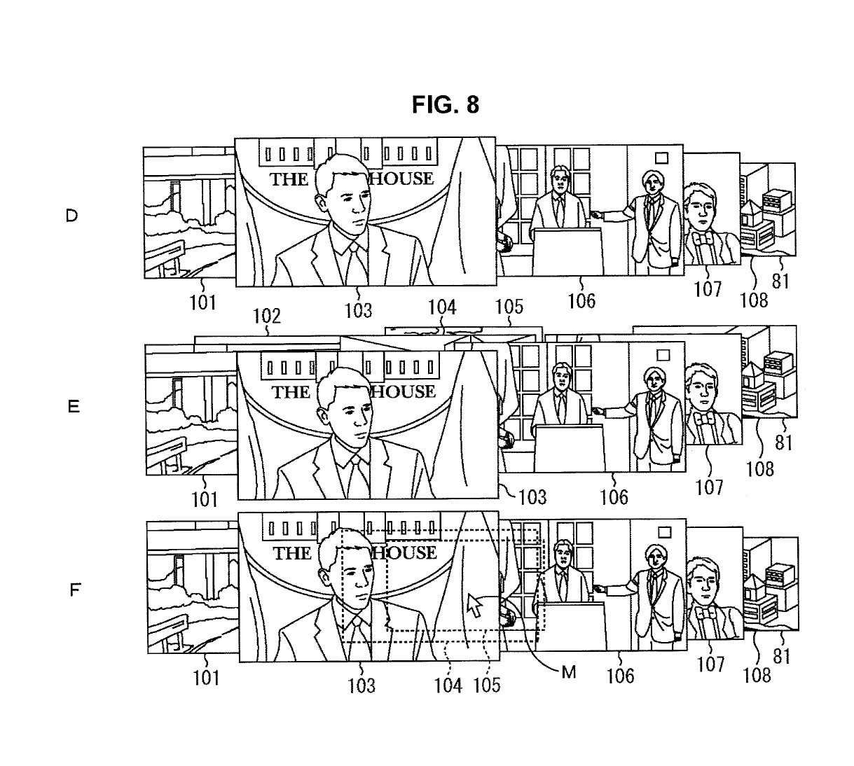

D of FIG. 8 shows the scene change image display section 81, changed from the display in C of FIG. 7, in the case of displaying of thumbnail image of the more important scene on the more front side. In other words, in the scene change image display section 81 in D of FIG. 8, the thumbnail image 103 of the most important scene is displayed on the most front side, and the thumbnail images 101 and 106 of the important scenes are displayed on the second front side. Further, the thumbnail images 102, 104, and 107 of the slightly important scenes are displayed on the third front side, and the thumbnail images 105 and 108 of the unimportant scenes are displayed on the most back side. However, the thumbnail images 102, 104, and 105 are actually hidden.

E of FIG. 8 shows the scene change image display section 81, changed from the display of in D of FIG. 8, in the case of displaying with upper edges of the images being displaced in accordance with the importance so as not to completely hide any thumbnail image.

In other words, in the scene change image display section 81 in E of FIG. 8, the respective thumbnail images are displayed in a manner that the thumbnail images 102, 104, and 105 hidden in the case of D of FIG. 8 are found to exist behind the thumbnail images 101, 103, and 106.

Here, the example in E of FIG. 8 shows an example of displaying with the upper edges being displaced, but, lower edges may be displaced and displayed similarly.

F of FIG. 8 shows the scene change image display section 81, similar to the display in D of FIG. 8, in the case of the thumbnail images 102, 104, and 105 being hidden. However, in the scene change image display section 81 in F of FIG. 8, the scenes of the hidden thumbnail images are shown in manner that profiles of the hidden thumbnail images are displayed using a dotted line upon a mouseover event of an arrow M indicating a position of a mouse onto the hidden thumbnail images of the scenes in response to the user operation. Further, upon a mouseover event of the arrow M indicating a position of a mouse onto the displayed profile in response to the user operation, the thumbnail image corresponding thereto is displayed on the most front side.

As described above, since the scene change image (thumbnail image) in the scene change image display section 81 is displayed in accordance with the importance based on the feature amount selected by the user, the user can easily grasp the substance of the content.

Note that as for the thumbnail image in the scene change image display section 81, the above description is given of the example in which the importance is determined depending on the feature amount selected by the user in the feature amount list 64. On the other hand, as for the thumbnail image in the face image display section 85 and object image display section 86, attributes of each object (also including a face) can be selectable by the user, and an object image (thumbnail image) corresponding to the selected attribute is determined to be the most important image.

For example, more detailed attributes concerning the face are extracted which include sex, age, smile determination, or person's name for the face image from the facial recognition. More detailed attributes concerning the object are extracted which include object's proper name, or object's color for the object image from the object recognition. In the case of human speech information, attributes are extracted which include male or female voice, person of speech, or music recognition. In the case of the camera motion information, attributes are extracted which include pan, tilt, zoom-in or zoom-out.

Additionally, as for the thumbnail image in the face image display section 85 and object image display section 86, the attributes extracted as described above are configured to be selectable such that an image (thumbnail image) corresponding to the attribute selected by the user is determined to be an important image. In accordance with the importance determined in this way, each image can be displayed with a size being varied or a side for display being varied between front and back.

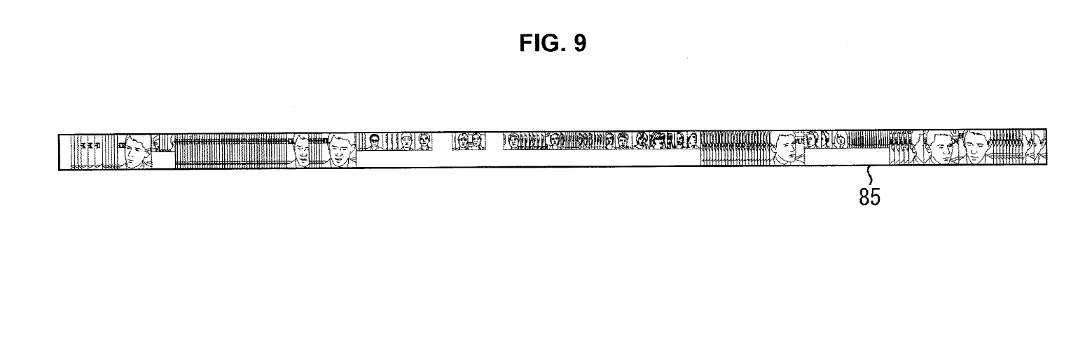

FIG. 9 shows an example of the face image display section 85 in the case of selecting a certain person as one of the detailed attributes.

In other words, in the face image display section 85 in FIG. 9, the face image of the certain person is extracted from the face images and the extracted face image is displayed larger in size than other face images.

This enables the user to easily recognize the important scene also for the object image.

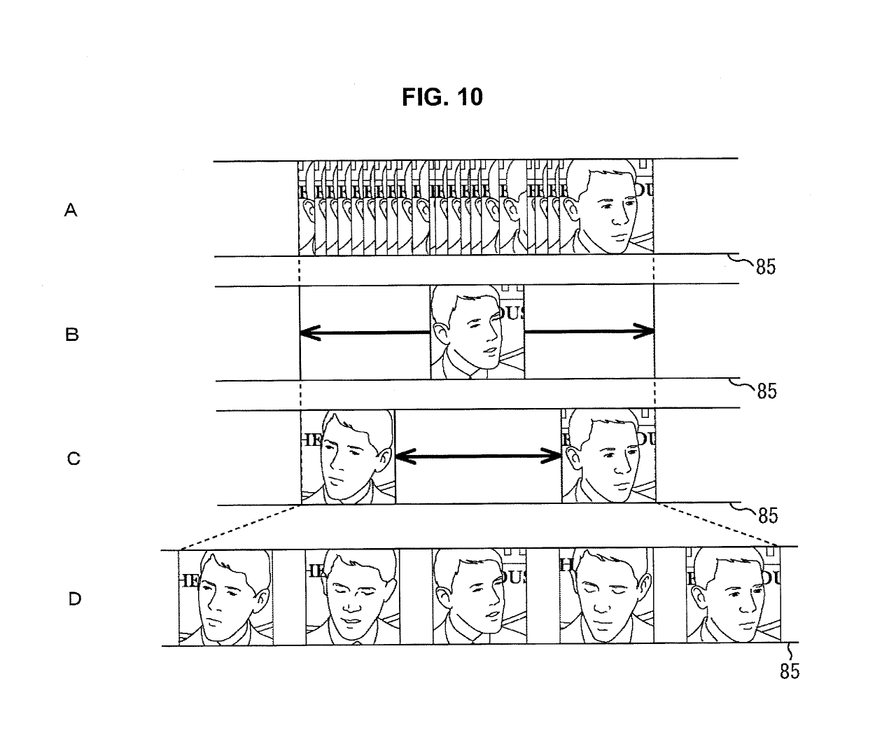

Further, a description will be given of the object image (thumbnail image) in the face image display section 85 and object image display section 86 with reference to FIG. 10.

For example, in the case of the face image display section 85 in FIG. 5 as an example of the object image, the thumbnail image is displayed along the time line with respect to all the frame images from which the face image is extracted. That is, as shown in A of FIG. 10, an identical object (face of the certain person) is successively displayed so that the object images are displayed in an overlapped manner.

In order to address this, the identity of the detected objects is recognized, and in a zone in which the identical object successively appears, the display control part 25 displays a representative one of a plurality of successive object images as shown in B of FIG. 10. Then, the display control part 25 displays a marking of an arrow, rectangle or the like for the zone.

Here, selected as representative one is a head image or middle image of the successive object images, an image having the highest accuracy of the object recognition in the object detection, the most average image of the successive object images, or an image which is determined to be important due to the selection of the object attribute by the user.

As the rectangle for displaying the zone, a representative color of a series of object images is displayed, for example. The representative color is decided from a color frequently appearing in the detected object, a color frequently appearing in a background portion of the object or the like, for example. Here, of the zones in which the identical object successively appears, if the object is not detected in a very short zone due to detection accuracy, the zone may be interpolated so as to be determined as a zone from which the object is detected.

Additionally, if a zone in which the identical object appears is long and two object images can be displayed without being overlapped with each other, the number of the displayed object image is not limited to one. In the case like this, as shown in C of FIG. 10, a head image and last image of a zone in which the identical object appears may be displayed, for example.

Further, if a zone in which the identical object appears is long, or also a zone in which the identical object appears can be elongated by zooming in the time line, the displayed object image is not limited to one representative image. In the case like this, as shown in D of FIG. 10, the object image of a timing corresponding to an interval in the zone to be filled may be displayed at that timing, depending on the length of the zone. This enables the display control part 25 to display a plurality of object images at a certain interval depending on the length of the zone without overlapping the images.

In the case also that the successive images of the identical object are displayed without being overlapped with each other as shown in B of FIG. 10 to D of FIG. 10, it is also possible to display with a size being varied or a side for display being varied between front and back in accordance with the importance of the object image determined depending on the attribute selected by the user. In the case like this, the display control part 25 determines the importance of the identical object within a zone in which the identical object appears, and displays with a size of the image being varied or a side for display being varied between front and back. Alternatively, the display control part 25 may determine the importance of the each image within a zone in which the identical object appears, and if the importance of each image is different from each other, overlapping in that zone may be permitted to display the more important images the more widely and on the more front side. Alternatively, the display control part 25, with an image to be displayed in this way taken into account, displays other object images at a timing in a manner that an interval corresponding to the timing in the zone is to be filled, with other object images being not overlapped.

As described above, in the preview screen for checking the substance of the moving picture content by the user, the information concerning various feature amounts of the content is displayed along the time line, enabling the user to easily grasp the substance of the content.

Moreover, the user can select each of the feature amounts, or weight the importance and select the feature amount in order to select the user intended important scene, according to which the scene change image can be displayed with a size being varied or a side for display being varied between front and back. This makes it possible to easily recognize a scene important for the user, enabling more efficient grasp of the substance of the content.

Further, as for the object extracted from the content, the detected object can be displayed with being less overlapped and the importance can determined depending on the attribute selected by the user to display the important image with a size being varied or a side for display being varied between front and back. This enables more efficient grasp of the substance of the content.

### 2. Second Embodiment (Digest Generation in Accordance with Importance)

### Information Processing Apparatus Configuration of Present Technology

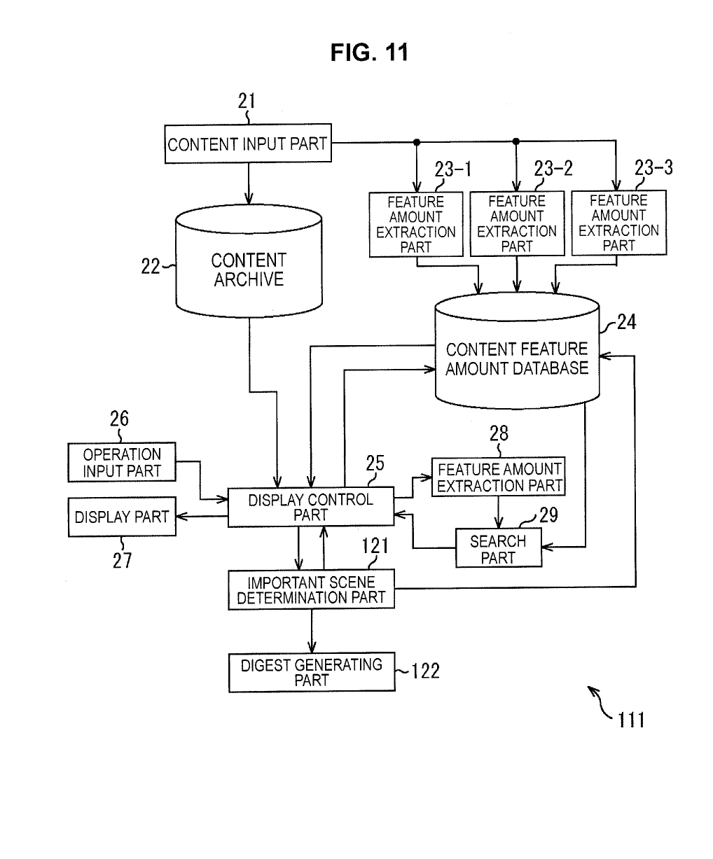

FIG. 11 is a diagram showing another configuration example of an information processing apparatus applying the present technology.

In the example in FIG. 11, an information processing apparatus 111, similarly to the information processing apparatus 11 in FIG. 1, displays the information concerning the feature amounts of content extracted from the content by way of a recognize technology such as image recognition, speech recognition, and character recognition in a screen for previewing content along the time line.

Moreover, the information processing apparatus 111, similarly to the information processing apparatus 11 in FIG. 1, determines the importance of each scene depending on the feature amount selected by the user. However, at that time, different from the information processing apparatus 11 in FIG. 1, the information processing apparatus 111 extracts a scene in accordance with the importance and collects the extracted scene to generate a digest moving image or record a start point and a end point as metadata.

The information processing apparatus 111 includes the content input part 21, content archive 22, feature amount extraction parts 23-1 to 23-3, content feature amount database 24, display control part 25, operation input part 26, display part 27, feature amount extraction part 28, and search part 29, which is common to the information processing apparatus 11 in FIG. 1.

The information processing apparatus 111 is added with an important scene determination part 121 and digest generating part 122, which is different from the information processing apparatus 11 in FIG. 1.

In other words, the display control part 25, in displaying the preview screen, redisplays the preview screen on the basis of the search result and the feature amount (information concerning the feature amount) which is input via the operation input part 26 and of which display or non-display is selected by the user. At that time, the display control part 25 determines importance of each scene depending on the feature amount selected by the user, and redisplays the preview screen 51 of FIG. 6 having the importance displayed.

In addition, the display control part 25, at a time when receiving a signal for requesting for digest generation by the user via the operation input part 26, displays the digest generating display section 65 in the preview screen 51. Then, the display control part 25, at a timing when receiving importance desired by the user via the operation input part 26, controls the important scene determination part 121 to extract a scene in accordance with the importance and displays the thumbnail image of the extracted scene in the digest generating display section 65.

The important scene determination part 121 extracts a scene in accordance with the importance from the display control part 25 and supplies the extracted scene to the display control part 25 and the digest generating part 122. The important scene determination part 121 stores information on the start point and end point of the extracted important scene as the metadata in the content feature amount database 24, for example. Alternatively, the important scene determination part 121 generates one or more thumbnail images representing the content by use of still images captured from those scenes.

Alternatively, the digest generating part 122 generates a digest moving image using the scene supplied from the important scene determination part 121. The generated digest moving image is recorded in a storage not shown in the figure.

In other words, in the case that the determined importances are classified into a plurality of stages, the display control part 25 selects the importance desired by the user. Then, the important scene determination part 121 extracts a scene in accordance with the importance to store the metadata thereof, or generate the thumbnail image, or the digest generating part 122 generates the digest moving image.

[Operation of Information Processing Apparatus]

Note that the content input process of the information processing apparatus 111 is carried out basically similar to the content input process of the information processing apparatus 11 described above with reference to FIG. 2, and the description thereof is omitted to prevent the duplicate description.

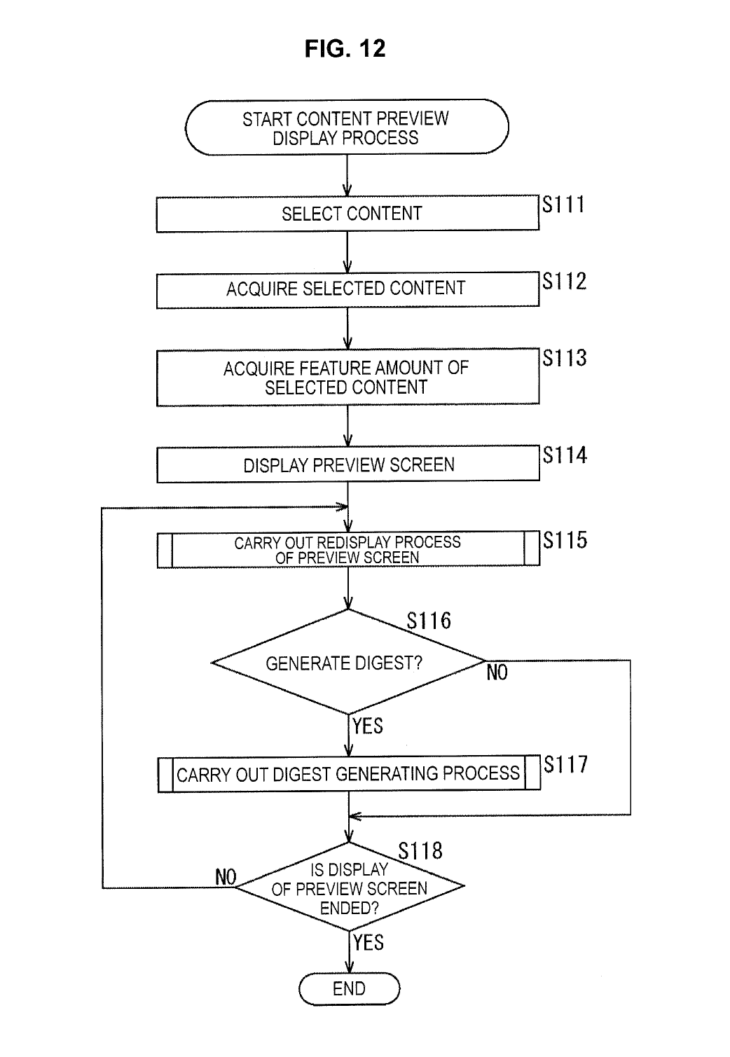

Subsequently, a description will be given of a preview display process of content in the information processing apparatus 111 with reference to a flowchart in FIG. 12. Here, steps S111 to S115, and S118 in FIG. 12 carry out basically the same process as steps S31 to S36 in FIG. 3, and thus, the description thereof is adequately omitted to prevent the duplicate description.

At step S111, the display control part 25 selects the content according to the information from the operation input part 26. At step S112, the display control part 25 acquires the content selected at step S111 from the content archive 22.

At step S113, the display control part 25 acquires the feature amount of the content selected at step S111 from the content feature amount database 24.

At step S114, the display control part 25 displays a preview screen. In other word, the display control part 25 generates the preview screen in which the information concerning the various feature amounts are displayed along the time line on the basis of the acquired content and the acquired content feature amount, and controls the display part 27 to display the generated preview screen (preview screen 51 shown FIG. 5).

At step S115, the display control part 25 carries out a redisplay process of the preview screen described above with reference to FIG. 4. In a process at step S115, the preview screen is displayed on the display part 27, the preview screen being updated in response to the user instruction supplied from the operation input part 26. In other words, the importance is found by being determined depending on the feature amount selected by the user in the feature amount list 64, and the preview screen 51 in FIG. 6 having the importance displayed is displayed in the display part 27.

At step S116, the display control part 25 determines whether or not a digest is to be generated.

For example, the user operates the operation input part 26 to select a tab of the digest generating display section 65 in the preview screen 51 of tabs each provided in the upper left of the time line display part 62 and the digest generating display section 65.

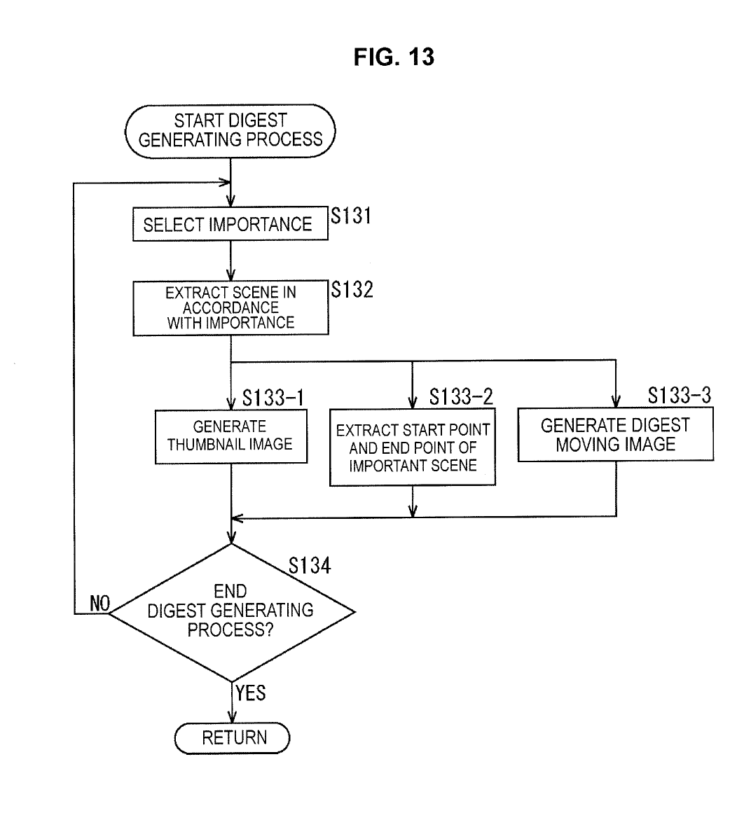

In response to this, the display control part 25 determines at step S116 that the digest is to be generated, and the process proceeds to step S117. At step S117, the important scene determination part 121 and the digest generating part 122 carry out the digest generating process. This digest generating process will be described later with reference to FIG. 13. The process at step S117, in accordance with the selected importance, generates the digest moving image, stores the metadata thereof, or generates the thumbnail image.

If the tab of the digest generating display section 65 is not selected, it is determined at step S116 that the digest is not to be generated, and the process of step S117 is skipped and the process proceeds to step S118.

At step S118, the display control part 25 determines whether or not display of the preview screen ends. If the user issues an instruction for the end via the operation input part 26, at step S118, the preview screen is determined to end and the display of the preview screen ends.

On the other hand, at step S118 if the displaying the preview screen is determined not to end, the process returns to step S115 and repeats step S115 and the subsequent steps.

Subsequently, a description will be given of the digest generating process of step S117 in FIG. 12 with reference to a flowchart in FIG. 13.

For example, at step S115 in FIG. 12, the preview screen 51 is redisplayed and the importance is displayed in the importance display section 91 in FIG. 6. When the tab of the digest generating display section 65 is selected in this preview screen 51, the digest generating display section 65 is displayed as shown in FIG. 14 of next figure in place of the time line display part 62.

In the digest generating display section 65 in FIG. 14, a band of the importance of the scene is displayed and superimposed on each of all the scene change images. Here, the importance is classified into three stages, and importance 3 indicates the highest importance.

A solid black band in FIG. 14 corresponds to the solid black region in the importance display section 91 in FIG. 6, and indicates the most important (importance 3) scene. A fine-hatched region in FIG. 14 corresponds to the fine-hatched region in the importance display section 91 in FIG. 6, and indicates a scene of importance 2. Further, a diagonal-hatched band in FIG. 14 corresponds to the diagonal-hatched region in the importance display section 91 in FIG. 6, and indicates a scene of importance 1.

Here, in the example in FIG. 14, the band is not superimposed on a scene of importance lower than the importance 1.

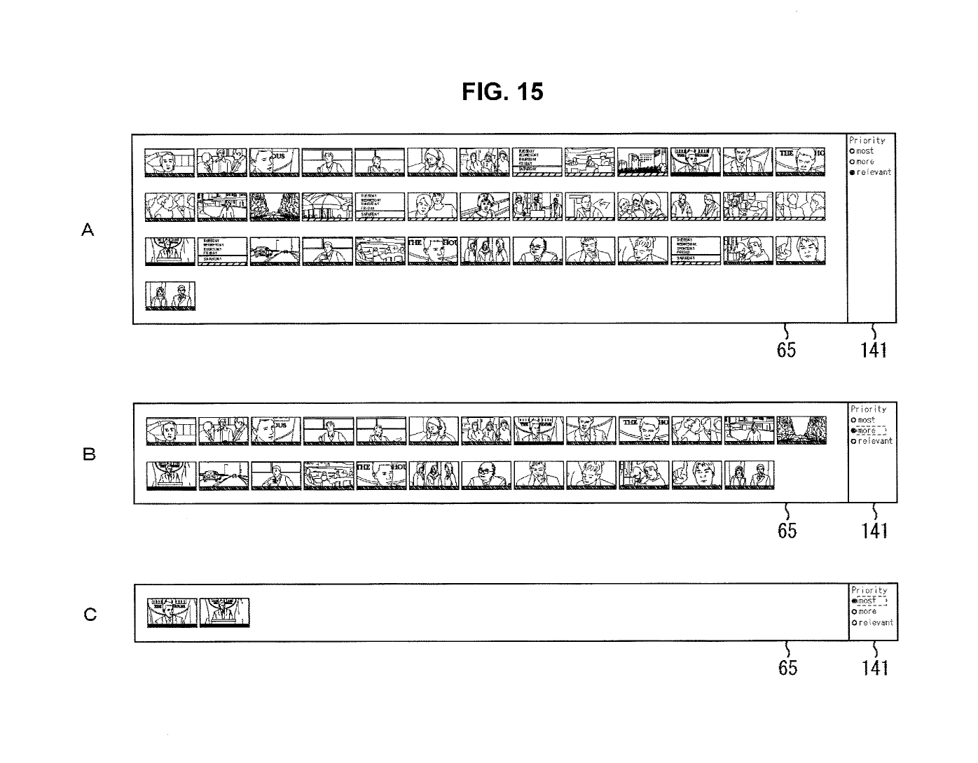

Then, for example, the user selects the importance. For example, as shown in A of FIG. 15, displayed on the right side of the digest generating display section 65 is an importance selecting section 141 for selecting a priority (importance) from “most (most important)”, “more (more important)”, and “relevant (proper)”.

The user operates the operation input part 26 to select the importance in the importance selecting section 141. In response to this, the display control part 25 at step S132 controls the important scene determination part 121 to extract a scene in accordance with the importance. The information on the extracted scene is supplied to the display control part 25, and the display control part 25 displays the importance selecting section 141 as shown in A of FIG. 15 to C of FIG. 15.

For example, if “relevant” is selected, the thumbnail image of the scene of importance 1 or more is extracted, the importance selecting section 141 displays therein the thumbnail image the scene of importance 1 or more as shown in A of FIG. 15. For example, if “more” is selected, the thumbnail image of the scene of importance 2 or more is extracted, the importance selecting section 141 displays therein the thumbnail image the scene of importance 2 or more as shown in B of FIG. 15. For example, if “most” is selected, the thumbnail image of the scene of importance 3 or more is extracted, the importance selecting section 141 displays therein the thumbnail image the scene of importance 3 or more as shown in C of FIG. 15.

Then, at step S133-1, the important scene determination part 121 generates one or more thumbnail images representing the content by use of still images captured from those scenes.

Alternatively, at step S133-2, the important scene determination part 121 stores information on the start point and end point of the extracted important scene as the metadata in the content feature amount database 24.

Alternatively, at step S133-3, the digest generating part 122 generates a digest moving image using the scene supplied from the important scene determination part 121. The generated digest moving image is recorded in a storage not shown in the figure.

Here, the processes of steps S133-1 to S133-3 are shown in parallel, because any one process may be performed, and at least two processes may be performed in parallel.

At step S134, the display control part 25 determines whether or not the digest generating process ends. For example, the user operates the operation input part 26 to select a tab of the time line display part 62 in the preview screen 51 of tabs each provided in the upper left of the time line display part 62 and the digest generating display section 65.

In response to this, the display control part 25 determines at step S134 that the digest generating process ends, and displays the time line display part 62 in place of the digest generating display section 65 to end the digest generating process.

On the other hand, if determined at step S134 that the digest generating process does not end, the process returns to step S131 and repeats step S131 and the subsequent steps.

As described above, the user can select the importance depending on the desired scene and generate a digest from the extracted scene. Alternatively, the user can store the information on the start point and end point of the extracted scene as the metadata to use in other applications and the like. Moreover, the representative image, for example, the scene change image, can be used to generate one or more thumbnail images representing the content. Since this thumbnail image is extracted from the important scene, an effect is given that the substance of the content may be is readily gotten by merely looking at the thumbnail image as compared with the method of related art in which the top image of the scene is the thumbnail image.

Here, as for the selection of the importance, it is possible to display the length of a digest moving image generated from the scene extracted in switching the importance, select the importance such that the moving image has the length close to that the user desires and generate the digest moving image.

Alternatively, it is possible that the user inputs the desired length in the information processing apparatus 111 in advance, the importance is automatically selected such that the digest moving image having the length close to that length is generated in accordance the importance, and the digest is generated.

[Another Example of Digest Generation]

Next, there is another method for more easily generating a digest in which one or more images selected by the user can be used to extract a similar scene and generate a digest.

For example, in the image search result display section 84 in the preview screen 51 in FIG. 5, with respect to the feature amount of which the user searches for the scene similar to the input image, not only one image but a plurality of images can be input to search for the scene similar to each of the images. Then, a relevant region can be extracted as the important scene from a search result of the similar scene to generate the digest moving image and the thumbnail image.

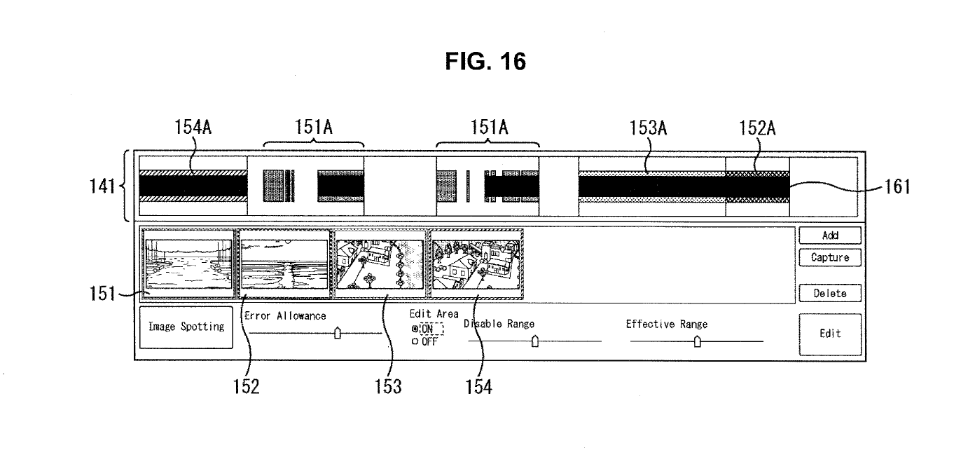

An example in FIG. 16 illustrates an example in which four characteristic images 151 to 154 are input, and scenes similar to the respective images are searched for to extract the important scene from the searched similar scenes.

Displayed along a time line 141 are a zone 154A of a scene similar to an image 154, a zone 151A of a scene similar to an image 151, a zone 153A of a scene similar to an image 153, and a zone 152A of a scene similar to an image 152. Then, among them, a zone 161 of solid black is extracted as a material zone of the digest moving image by selecting parameters including detection accuracy, noise correction of error detection zone and selection of a zone over a certain period of time by the user.

As other feature amounts, scene change information, information on break in a sound and the like can be used to more flexibly and adequately extract the scene. From the scenes in these extracted zones, the digest moving image and the thumbnail image can be generated and the start point and end point of the important scene can be extracted.

As described above, since various feature amounts are extracted from the moving image content using the recognition technology such as the speech recognition and the image recognition such that the user can arbitrarily select each feature amount, the user' intention can be reflected in more detail to extract the important scene of the content.

Further, since the similar scene is searched for from one or more characteristic images selected arbitrarily by the user, the user intended important scene can be flexibly selected.

The utilization of this importance makes it possible to generate the thumbnail image and digest moving image to which the user's intention is more reflected with respect the moving image content.

The series of processes described above can be executed by hardware but can also be executed by software. When the series of processes is executed by software, a program that constructs such software is installed into a computer. Here, the expression “computer” includes a computer in which dedicated hardware is incorporated and a general-purpose personal computer or the like that is capable of executing various functions when various programs are installed.

### 3. Third Embodiment (Computer)

### Configuration Example of Computer

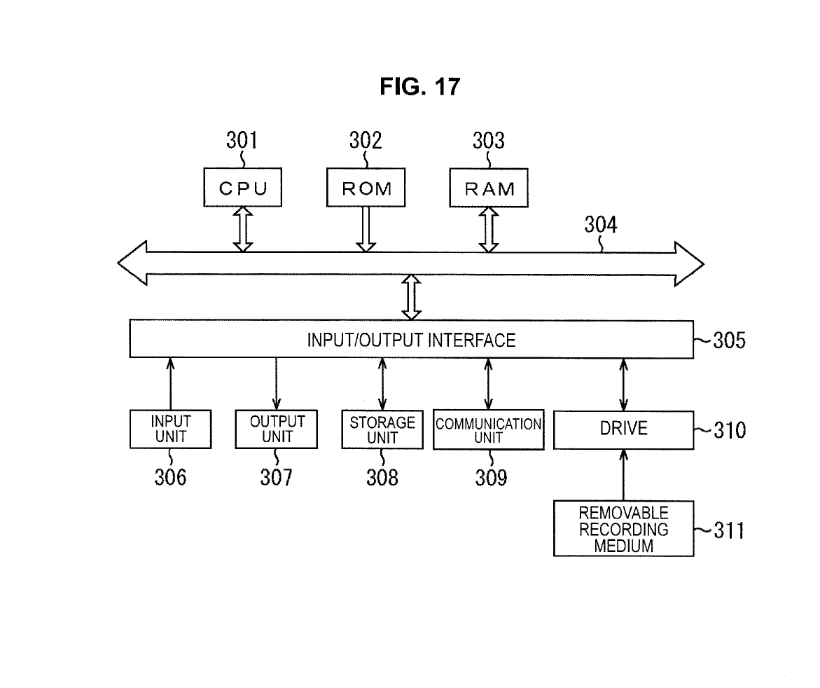

FIG. 17 illustrates a configuration example of hardware of a computer that executes the above series of processes by programs.

In a computer 300, a central processing unit (CPU) 301, a read only memory (ROM) 302 and a random access memory (RAM) 303 are mutually connected by a bus 304.

An input/output interface 305 is also connected to the bus 304. An input unit 306, an output unit 307, a storage unit 308, a communication unit 309, and a drive 310 are connected to the input/output interface 305.

The input unit 306 is configured from a keyboard, a mouse, a microphone or the like. The output unit 307 configured from a display, a speaker or the like. The storage unit 308 is configured from a hard disk, a non-volatile memory or the like. The communication unit 309 is configured from a network interface or the like. The drive 310 drives a removable recording medium 311 such as a magnetic disk, an optical disk, a magneto-optical disk, a semiconductor memory or the like.

In the computer configured as described above, the CPU 301 loads a program that is stored, for example, in the storage unit 308 onto the RAM 303 via the input/output interface 305 and the bus 304, and executes the program. Thus, the above-described series of processing is performed.

As one example, the program executed by the computer (the CPU 301) may be provided by being recorded on the removable recording medium 311 as a packaged medium or the like. The program can also be provided via a wired or wireless transfer medium, such as a local area network, the Internet, or a digital satellite broadcast.

In the computer, by loading the removable recording medium 311 into the drive 310, the program can be installed into the storage unit 308 via the input/output interface 305. It is also possible to receive the program from a wired or wireless transfer medium using the communication unit 309 and install the program into the storage unit 308. As another alternative, the program can be installed in advance into the ROM 302 or the storage unit 308.

It should be noted that the program executed by a computer may be a program that is processed in time series according to the sequence described in this specification or a program that is processed in parallel or at necessary timing such as upon calling.

In the present disclosure, steps of describing the above series of processes may include processing performed in time-series according to the description order and processing not processed in time-series but performed in parallel or individually.

The embodiment of the present disclosure is not limited to the above-described embodiment. It should be understood by those skilled in the art that various modifications, combinations, sub-combinations and alterations may occur depending on design requirements and other factors insofar as they are within the scope of the appended claims or the equivalents thereof.

For example, the present technology can adopt a configuration of cloud computing which processes by allocating and connecting one function by a plurality of apparatuses through a network.

Further, each step described by the above mentioned flow charts can be executed by one apparatus or by allocating a plurality of apparatuses.

In addition, in the case where a plurality of processes is included in one step, the plurality of processes included in this one step can be executed by one apparatus or by allocating a plurality of apparatuses.

Further, an element described as a single device (or processing unit) above may be divided to be configured as a plurality of devices (or processing units). On the contrary, elements described as a plurality of devices (or processing units) above may be configured collectively as a single device (or processing unit). Further, an element other than those described above may be added to each device (or processing unit). Furthermore, a part of an element of a given device (or processing unit) may be included in an element of another device (or another processing unit) as long as the configuration or operation of the system as a whole is substantially the same. In other words, an embodiment of the disclosure is not limited to the embodiments described above, and various changes and modifications may be made without departing from the scope of the technology.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

Additionally, the present technology may also be configured as below.

(1) An information processing apparatus including:

a plurality of feature amount extraction parts configured to extract, from content, a plurality of feature amounts;

a display control part configured to control display of an image of the content and information concerning the feature amounts of the content; and

a selecting part configured to select display or non-display of the information concerning the feature amounts,

wherein the display control part controls display of importance of a scene found on the basis of the display or non-display of the information concerning the feature amounts which is selected by the selecting part.

(2) The information processing apparatus according to (1), wherein

the display control part changes the display of the information concerning the feature amounts in accordance with the importance.

(3) The information processing apparatus according to (2), wherein

the display control part controls display of a scene head image as the information concerning feature amounts in accordance with the importance.

(4) The information processing apparatus according to (3), wherein

the display control part displays a scene head image high in the importance in a manner that the scene head image high in the importance is larger in size than a scene head image low in the importance.

(5) The information processing apparatus according to (3), wherein

the display control part displays a scene head image high in the importance in front of a scene head image low in the importance.

(6) The information processing apparatus according to (2), wherein

the display control part controls display of an object image in which a predetermined object is detected as the information concerning feature amounts in accordance with the importance.

(7) The information processing apparatus according to (6), wherein

the display control part displays an object image high in the importance in a manner that the object image high in the importance is larger in size than an object image low in the importance.

(8) The information processing apparatus according to (6), wherein

the display control part displays an object image high in the importance in front of an object image low in the importance.

(9) The information processing apparatus according to (6), wherein

the display control part, in a case where an object image high in the importance is successively detected along a time line, displays one or more object images high in the importance in a zone in which the object image high in the importance is successively detected.

(10) The information processing apparatus according to any one of (1) to (9), further including:

a change part configured to change weighting of the importance,

wherein the display control part changes the display of the information concerning the feature amounts in accordance with the importance of which weighting is changed by the change part.

(11) The information processing apparatus according to (1), further including:

a scene extraction part configured to extract a scene in accordance with the importance.

(12) The information processing apparatus according to (11), further including:

a digest generating part configured to the scene extracted by the scene extraction part, and to generate a digest moving image.

(13) The information processing apparatus according to (11), further including:

a metadata generating part configured to generate digest metadata including a start point and an end point of the scene extracted by the scene extraction part.

(14) The information processing apparatus according to (11), further including:

a thumbnail generating part generating a thumbnail image which represents the content from an image of the scene extracted by the scene extraction part.

(15) The information processing apparatus according to any one of (11) to (14), further including:

a change part configured to change weighting of the importance,

wherein the scene extraction part extracts the scene in accordance with the importance of which weighting is changed by the change part.

(16) An information processing method including:

extracting, an information processing apparatus, from content, a plurality of feature amounts;

controlling, by the information processing apparatus, display of an image of the content and information concerning the feature amounts of the content;

selecting, by the information processing apparatus, display or non-display of the information concerning the feature amounts; and

controlling, by the information processing apparatus, display of importance of a scene found on the basis of the display or non-display of the information concerning the feature amounts, which has been selected.

(17) A program causing a computer to function as:

a plurality of feature amount extraction parts configured to extract, from content, a plurality of feature amounts;

a display control part configured to control display of an image of the content and information concerning the feature amounts of the content; and

a selecting part configured to select display or non-display of the information concerning the feature amounts,

wherein the display control part controls display of importance of a scene found on the basis of the display or non-display of the information concerning the feature amounts, which has been selected by the selecting part.

What is claimed is:

1. An information processing apparatus comprising:
a plurality of feature amount extraction parts configured to extract, from content, a plurality of feature amounts;
a display control part configured to control display of an image of the content and information concerning the feature amounts of the content; and
a selecting part configured to select display or non-display of the information concerning the feature amounts,
wherein the display control part controls display of importance of a scene found on the basis of the display or non-display of the information concerning the feature amounts which is selected by the selecting part.

2. The information processing apparatus according to claim 1, wherein
the display control part changes the display of the information concerning the feature amounts in accordance with the importance.

3. The information processing apparatus according to claim 2, wherein
the display control part controls display of a scene head image as the information concerning feature amounts in accordance with the importance.

4. The information processing apparatus according to claim 3, wherein
the display control part displays a scene head image high in the importance in a manner that the scene head image high in the importance is larger in size than a scene head image low in the importance.

5. The information processing apparatus according to claim 3, wherein
the display control part displays a scene head image high in the importance in front of a scene head image low in the importance.

6. The information processing apparatus according to claim 2, wherein
the display control part controls display of an object image in which a predetermined object is detected as the information concerning feature amounts in accordance with the importance.

7. The information processing apparatus according to claim 6, wherein
the display control part displays an object image high in the importance in a manner that the object image high in the importance is larger in size than an object image low in the importance.

8. The information processing apparatus according to claim 6, wherein
the display control part displays an object image high in the importance in front of an object image low in the importance.

9. The information processing apparatus according to claim 6, wherein
the display control part, in a case where an object image high in the importance is successively detected along a time line, displays one or more object images high in the importance in a zone in which the object image high in the importance is successively detected.

10. The information processing apparatus according to claim 2, further comprising:
a change part configured to change weighting of the importance,
wherein the display control part changes the display of the information concerning the feature amounts in accordance with the importance of which weighting is changed by the change part.

11. The information processing apparatus according to claim 1, further comprising:
a scene extraction part configured to extract a scene in accordance with the importance.

12. The information processing apparatus according to claim 11, further comprising:
a digest generating part configured to the scene extracted by the scene extraction part, and to generate a digest moving image.

13. The information processing apparatus according to claim 11, further comprising:
a metadata generating part configured to generate digest metadata including a start point and an end point of the scene extracted by the scene extraction part.

14. The information processing apparatus according to claim 11, further comprising:
a thumbnail generating part generating a thumbnail image which represents the content from an image of the scene extracted by the scene extraction part.

15. The information processing apparatus according to claim 11, further comprising:
a change part configured to change weighting of the importance,
wherein the scene extraction part extracts the scene in accordance with the importance of which weighting is changed by the change part.

16. An information processing method comprising:
extracting, an information processing apparatus, from content, a plurality of feature amounts;
controlling, by the information processing apparatus, display of an image of the content and information concerning the feature amounts of the content;
selecting, by the information processing apparatus, display or non-display of the information concerning the feature amounts; and
controlling, by the information processing apparatus, display of importance of a scene found on the basis of the display or non-display of the information concerning the feature amounts, which has been selected.

17. A program causing a computer to function as:
a plurality of feature amount extraction parts configured to extract, from content, a plurality of feature amounts;
a display control part configured to control display of an image of the content and information concerning the feature amounts of the content; and
a selecting part configured to select display or non-display of the information concerning the feature amounts,
wherein the display control part controls display of importance of a scene found on the basis of the display or non-display of the information concerning the feature amounts, which has been selected by the selecting part.
